(19) United States
(12) Patent Application Publication
(10) Pub. No.: US 2024/0023475 A1
(43) Pub. Date: Jan. 25, 2024

(54) METHOD FOR THE CONTROLLED SEEDING OF A PARCEL OF AGRICULTURAL LAND AND SYSTEM FOR IMPLEMENTING SAME

(71) Applicant: KUHN SAS, Saverne (FR)

(72) Inventors: Benoît JARRASSIER, Ottersthal (FR); Philippe POTIER, Zittersheim (FR)

(73) Assignee: KUHN SAS, Saverne (FR)

(21) Appl. No.: 18/263,612

(22) PCT Filed: Feb. 3, 2022
(86) PCT No.: PCT/EP2022/052545

§ 371 Date: Jul. 31, 2023

(30) Foreign Application Priority Data
Feb. 5, 2021 (FR) 2101118

(51) Int. Cl. A01B 79/02; A01B 79/00

(52) U.S. Cl. CPC A01B 79/02; A01B 79/005

(57) ABSTRACT

A method for controlled seeding of a parcel of agricultural land by a seeding vehicle having a plurality of individual seeding members each producing a seeding line and being able to interrupt at least one seeding line so as to mark out the parcel, including: providing, in advance, a virtual plan of the parcel with the current portions of the arrangements of seeding lines to be realized; inferring therefrom the trajectories of the seeding vehicle; and controlling the latter to carry out controlled seeding with marking out for these current portions and for the particular trajectories at least during cornering, during U-turns or between the current portions, depending on the trajectories of the rolling members of the vehicle(s) or trailer(s) carrying out the subsequent operation(s) on these current portions.

The present invention concerns the field of agricultural machinery and methods, more particularly seeding, and relates to a method and a system for the controlled seeding with tramlining of a plot of land.

During the steps of seeding and treating (for example spraying, hoeing, fertilization) a plot of land, the tractor and the tools it carries often take the same trajectories (travel lanes or tracks). It is therefore impossible to cultivate them since they are crushed during each operation.

Generally, the straight segments inside the plot as well as the straight segments in the headland (peripheral portion surrounding, where applicable, at least partially the main interior area of the plot) are tramline. Tramlining consists in switching off the seeder elements of the seeder corresponding to the wheel tracks of the tractor/tool to avoid wasting seeds.

To optimize the number of trajectories (and therefore limit crushing), the farmer often chooses tools/machines whose widths are multiples of the working widths of the other tools/machines used previously or subsequently, in particular the working width of the mounted or trailed seeder. This therefore restricts the farmer's choice regarding the machines to be purchased and/or used if he wants to reduce the losses due to crushing. For example, the choice of machine used for the spraying step, in particular its working width, is directly affected by the working width and dimension of the wheel tracks of the seeder used previously and consequently by the type of tramlining that was applied when seeding.

Numerous methods and systems for tramlining straight path segments, forming the current portions of arrangements of seeding rows, are already known. Examples of such methods and systems are disclosed by the following documents: WO 2015/028127, EP 2 532 218, EP 0 702 888 and EP 0 176 023, or even implemented by the applicant with the “Section Control” technology.

However, tramlining in relation with trajectories that are not straight is, to date, not yet controlled, in particular since it is impossible to reproduce the trajectories identically depending on the equipment used and on the variable implementation conditions.

Consequently, cornering, U-turns and other maneuvers (in particular with trajectories that are not straight) are traditionally not tramlined, since their shapes and dimensions are not necessarily always exactly the same depending on the type of treatment tool (trailed/mounted), the working width, the maneuverability (presence or not of tracker or steering axles on the tool), the inclination of the land, the soil quality, the weather conditions on the day of the operation, etc.

In addition, it is very difficult fora driver to tramline these path portions precisely, even when he is assisted, or to follow this tramlining during subsequent agricultural operations.

Thus, the tractor driver-assistance systems (commonly called “self-drive” systems) make it easy to work inside the plot with assistance (management of the tractor speed and direction on straight or slightly curved segments) and therefore relatively easy to tramline this portion. Nevertheless, although some self-drive systems carry out the U-turns between straight segments themselves, the exact path of these U-turns is not known in advance (since adapted individually before each U-turn by the driver-assistance software). The same applies for some maneuvers such as the supply operations, which are even less automated since they cannot be handled by the existing self-drive systems. In addition, programming these self-drive software to include the above-mentioned special maneuvers would be tedious and would require advanced training for the user.

Lastly, the implementation of robot-controlled seeding and/or treatment vehicles having working widths that are often reduced increases the number of maneuvers and leads to crushing of the crops and tamping of the soil over large areas, especially at the opposite ends of the straight portions of the seeding rows, and therefore results in seed wastage.

The main objective of the present invention is to propose a method and a system for seeding in order to allow reducing seed wastage, in particular outside the straight portions of the arrangement of seeding rows of a plot, by limiting unproductive seeding, i.e. seeding not resulting in the production of a plant that can be harvested.

To this end, the invention relates to a method for the controlled seeding of a plot of land by way of a seeding vehicle or a machine combination with a seeder, having a plurality of single seeding elements each able and intended to produce a seeding row, this vehicle or machine combination being configured so as to be able to selectively, and at least temporarily, interrupt one, several or all the seeding row(s), by blocking and/or retracting the element(s) concerned, in order to tramline said plot while avoiding crushing the crops during the planned passage(s) of one or more known vehicle(s) or machine combination(s) intended to carry out one or more subsequent operation(s) on this plot,
said method consisting in providing, in advance, a virtual plan of the plot with the current, generally straight, portions of the arrangements of seeding rows to be produced, at least in a main interior region of said plot and possibly in a peripheral headland region bordering or surrounding, where applicable at least partially, this interior region, in inferring therefrom the trajectories of the seeding vehicle or machine combination and in controlling the latter to carry out controlled seeding with tramlining for these current portions, depending on the trajectories of the travel elements of the vehicle(s) or machine combination(s) carrying out the subsequent operation(s) on these current portions,
method characterized in that it also consists in providing and in taking into account the specific trajectories of the vehicle(s) or machine combination(s) carrying out the subsequent above-mentioned operation(s) at least during cornering, during U-turns or between the current portions, and in controlling the seeding vehicle or machine combination to carry out controlled seeding with tram lining also during these specific trajectories.

The invention will be better understood on reading the following description, which refers to preferred embodiments, given as non-limiting examples, and explained with reference to the attached schematic drawings, in which:

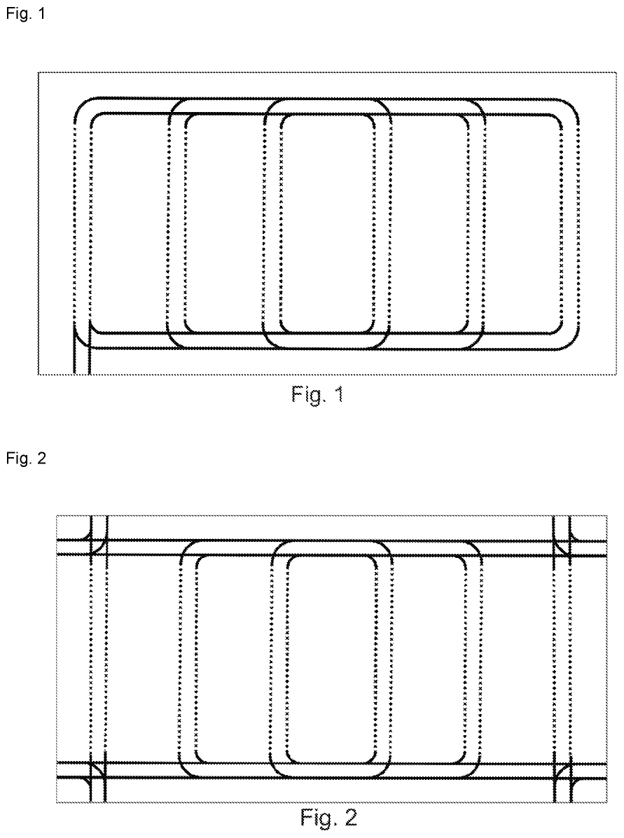

FIG. 1 provides a diagrammatic illustration, by representing the travel tracks, of an example of traditional tramlining of a plot (limited tramlining as carried out until now by the farmers), on this figure the tramlined trajectory portions are shown in dotted lines and the non-tramlined, and therefore seeded then crushed, portions are shown in solid lines, the outer frame representing the contour of the plot;

FIG. 2 shows a second example of a plot similar to that of FIG. 1 treated with traditional tramlining, this plot being worked in an alternative way compared with the example of FIG. 1 (the pattern of the wheel tracks is different, but the principle remains the same);

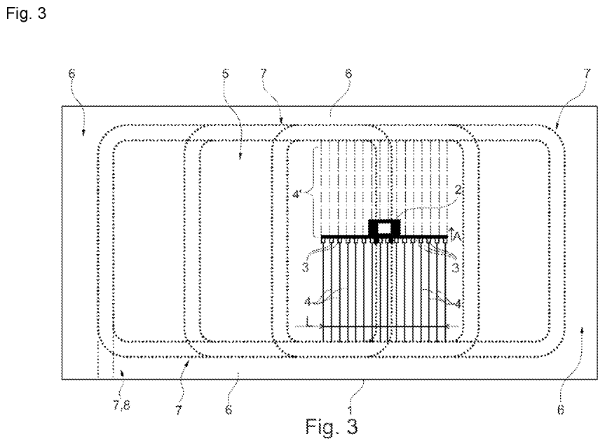

FIG. 3 shows total tramlining of the plot of FIG. 1, according to the invention, the pattern of the trajectory tracks being identical to that of said FIG. 1;

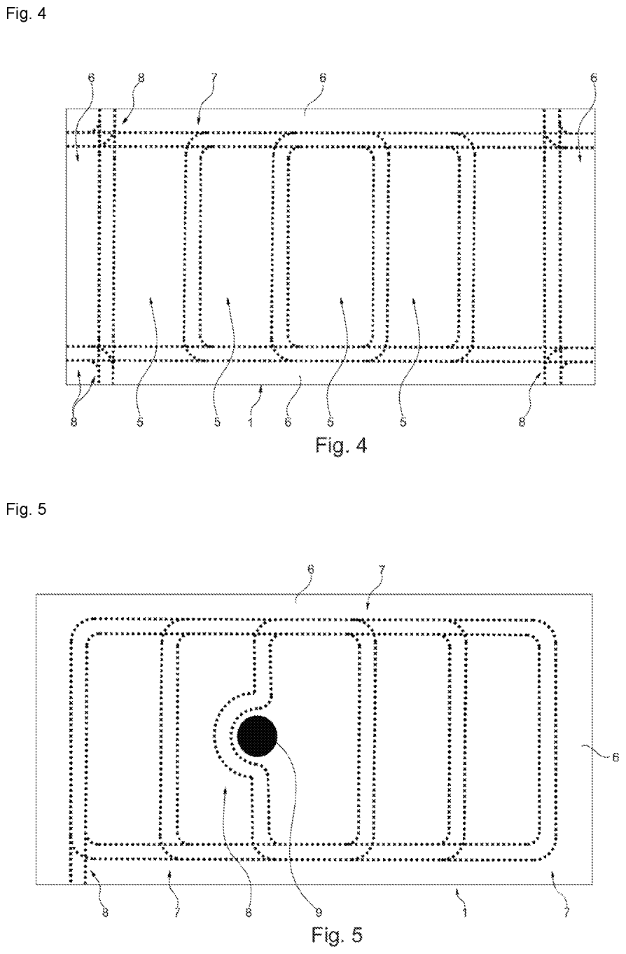

FIG. 4 shows total tramlining of the plot of FIG. 2, according to the invention, the pattern of the trajectory tracks being identical to that of said FIG. 2, and,

FIG. 5 and

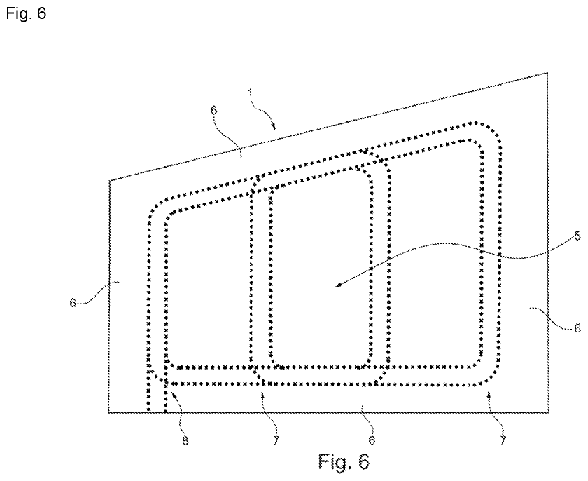

FIG. 6 show examples of total tramlining fora plot in which there is an obstacle (FIG. 5) and a plot which does not have a rectangular contour (FIG. 6).

The invention relates to a method for the controlled seeding of a plot (1) of land by way of a seeding vehicle or a machine combination with a seeder (2), having a plurality of single seeding elements (3) each able and intended to produce a seeding row (4), this vehicle or machine combination (2) being configured so as to be able to selectively, and at least temporarily, interrupt one, several or all the seeding row(s) (4), by blocking and/or retracting the element(s) (3) concerned, in order to tramline said plot (1) while avoiding crushing the crops during the planned passage(s) of one or more known vehicle(s) or machine combination(s) intended to carry out one or more subsequent operation(s) on this plot (1).

This method consists mainly in providing, in advance, a virtual plan of the plot with the current, generally straight, portions (4′) of the arrangements of seeding rows to be produced, at least in a main interior region (5) of said plot (1) and possibly in a peripheral headland region (6) bordering or surrounding, where applicable at least partially, this interior region (5), in inferring therefrom the trajectories of the seeding vehicle or machine combination (2) and in controlling the latter to carry out controlled seeding with tramlining for these current portions (4′), depending on the trajectories of the travel elements of the vehicle(s) or machine combination(s) carrying out the subsequent operation(s) on these current portions,

According to the invention, said method also consists in providing and in taking into account the specific trajectories (7, 8) of the vehicle(s) or machine combination(s) carrying out the subsequent above-mentioned operation(s) at least during cornering, during U-turns or between the current portions, and in controlling the seeding vehicle or machine combination (2) to carry out controlled seeding with tramlining also during these specific trajectories (7, 8).

By carrying out “total” tramlining of the plot considered, while taking into account during the seeding operation the trajectories and therefore the future travel tracks (in dotted lines on the various figures—strips not sown when seeding) of the vehicle(s) or machine combination(s) carrying out the subsequent operation(s), at least for the above-mentioned current maneuvers, the method according to the invention makes it possible to achieve the objective set, i.e. reduce seed wastage, in particular outside the straight portions of the arrangements of seeding rows of a plot, by limiting unproductive seeding.

Thus, in concrete terms, seeds are neither distributed in the pairs of generally parallel and straight soil strips located in the interior region of the plot (and corresponding to the rows) and used subsequently by the travel means of the agricultural machines or machine combinations carrying out operations subsequent to seeding, nor in the pairs of generally parallel, straight or not, soil strips located outside the interior region of the plot (and corresponding in particular to the junction, maneuvering, headland or turnrow lanes) and used subsequently by the travel means of these same agricultural machines or machine combinations.

When the plot considered does not include peripheral areas assigned to the maneuvers, the maneuvers take place inside the plot, thus reducing accordingly the interior region with the parallel and straight rows.

The subsequent operations which can normally be known when seeding, depending on the equipment used, include in particular the post-seeding and pre-harvesting operations such as hoeing, spraying, spreading, fertilization and irrigation.

Apart from the gains relating to the above-mentioned maneuvers, additional gains can be expected by advantageously providing that the method according to the invention further consists in determining and taking into account the specific trajectories (8) of the vehicle(s) or machine combination(s) carrying out the above-mentioned subsequent operation(s) during maneuvers associated with avoiding objects or obstacles (9), with entering or leaving the plot, with operations to load or supply inputs or with specific foreseeable operations, depending for example on the type of plant cultivated on the plot considered, the characteristics of its soil and/or the type of vehicle or machine combination concerned.

By comparing each of FIGS. 3 and 4 with respectively each of FIGS. 1 and 2, it is possible to evaluate visually the increase in tramlined area and therefore, proportionally, the saving of seeds not sown on the surfaces of the plot that are subsequently crushed, depending on the maneuvers taken into account.

According to an additional favorable feature, the method can consist in providing in advance, for the foreseeable maneuvers, models of the trajectories of the travel means of the various vehicles or machine combinations carrying out the subsequent operation(s) likely to be implemented on the plot (1) considered, taking into account a possible error or shift factor determined by measurements during implementations under real conditions.

This factor can be used to correct tramlining errors due to the type of land, such as for example a slope in the plot. These errors can also be due to mechanical elements present on the vehicle or machine combination carrying out a subsequent operation or on a tool associated with it.

These mechanical elements can, for example, correspond to “tracker” or “steering” axles which improve the steering radius of the machine combination (including the agricultural machine containing them) and simplify the maneuvers. However, they are not perfect and do not generally allow the trailed tool or machine to follow 100% the same tracks as the tractor vehicle. This type of “tracker axle”, with its “Track Assist” automatic guiding technology, based on the use of gyroscopes and GPS data, is implemented in particular by the Kuhn-Blanchard company on its “Meths 2” and “Oceanis 2” (registered trademarks) trailed sprayers.

This error factor can also make it possible to correct the human error naturally present in the maneuvers carried out by a driver.

According to an advantageous embodiment of the invention, the virtual plan of the plot (1) also comprises a division of its surface into work areas in relation with seeding recommendations, such as modulation of the dose of seed and/or fertilizer to be deposited, working speed, working depth, adjustment specific to at least one operating parameter of the seeding vehicle or machine combination (2) or similar.

These various recommendations can in particular be viewed and processed using an application, such as for example that known under the designation “EasyMaps” by the applicant.

Preferably, the controlled seeding of the plot (1) is carried out by a robot-controlled vehicle (2), operating autonomously or controlled remotely, having a working width (L) that is advantageously an integer submultiple of the working widths of the various vehicles or machine combinations carrying out the subsequent operation(s) likely to be implemented on the plot (1) considered, the latter also advantageously being of the robot-controlled machine type, operating autonomously or controlled remotely.

An example of implementation of such an automated treatment of a plot by robots is described in particular in the French patent applications FR 2 009 696 and FR 2 009 705.

The vehicle(s) or machine combination(s) carrying out the subsequent operation(s) can be of different types, such as for example: conventional tractor with driver, autonomous robot without driver, self-propelled vehicle, four-wheel all-terrain vehicle or similar, associated where applicable with at least one machine or at least one mounted, semi-mounted or trailed agricultural tool.

Similarly, the travel means of these vehicles or machine combinations can be of different types: wheels, tracks, mixed means or other, each having its specific features and properties.

All the above-mentioned specificities relating to the vehicle(s) or machine combination(s) carrying out the subsequent operation(s), and known in the prior art, are advantageously taken into account during the prior determination of the total tram lining strategy applied by the seeding vehicle (2).

According to a practical implementation of the invention relating to autonomous vehicles (such as agricultural robots), it is advantageously provided that the instructions to be observed for the total tramlining are generated when generating the work “mission” of the autonomous vehicle considered, i.e. at the time when the paths that the successive vehicles used will take, are defined.

This path is for example generated by dedicated software that the farmer uses by entering and/or providing the various features of the task to be carried out (information concerning the plot, possible obstacles, machine(s) to be used for seeding and subsequent operations, working speed, etc.). This path is then sent (totally or partially as progress is made) in the form of instructions to the various autonomous vehicles when starting the mission. A monitoring system (a unit for the control and management of the fleet of autonomous vehicles) is used to provide communication between the path generated beforehand and the agricultural robots implemented when carrying out the mission. Once the instructions have been received by the autonomous vehicle(s), software on board the vehicle considered controls the seeder (using for example the above-mentioned “Section control” technology) to sow the plot while respecting the planned total tramlining.

Similarly for the subsequent operations, the instructions sent to the vehicles will take into account the tracks of the total tramlining in order to ensure that it is respected.

The invention also relates to a system for implementing the controlled seeding method as described above.

This system comprises a seeding vehicle or a machine combination with a seeder (2), that is autonomous or semi-autonomous, having a plurality of single seeding elements (3), each able and intended to produce a seeding row (4), this vehicle or machine combination (2) being configured so as to be able to selectively, and at least temporarily, interrupt one, several or all the seeding row(s) (4), by blocking and possibly retracting the element(s) concerned.

This system is characterized in that the vehicle or machine combination (2) is equipped with control means comprising a computer means configured to use a virtual plan of the plot (1) to be sown and to define and execute a protocol for the travel and operation of said vehicle or machine combination (2) configured to carry out controlled seeding with selective tramlining over the entire plot (1) considered, according to the trajectories of the travel elements of the vehicle(s) or machine combination(s) carrying out the operation(s) subsequent to the seeding of this plot.

Preferably, the seeding vehicle or machine combination (2) is of the robot-controlled vehicle type, operating autonomously, semi-autonomously or controlled remotely.

Obviously, the invention is not limited to the embodiments described and shown in the attached drawings. Modifications remain possible, in particular as regards the composition of the various elements or the substitution by technical equivalents without departing from the scope of protection of the invention.

1. A method for the controlled seeding of a plot of agricultural land by way of a seeding vehicle or a machine combination with a seeder, having a plurality of single seeding elements each able and intended to produce a seeding row, this vehicle or machine combination being configured so as to be able to selectively, and at least temporarily, interrupt one, several or all the seeding row(s), by blocking and/or retracting the element(s) concerned, in order to tramline said plot while avoiding crushing the crops during the planned passage(s) of one or more known vehicle(s) or machine combination(s) intended to carry out one or more subsequent operation(s) on this plot,
said method comprising:
providing, in advance, a virtual plan of the plot with the current, generally straight, portions of the arrangements of seeding rows to be produced, at least in a main interior region of said plot and possibly in a peripheral headland region bordering or surrounding, where applicable at least partially, this interior region, in inferring therefrom the trajectories of the seeding vehicle or machine combination and in controlling the latter to carry out controlled seeding with tramlining for these current portions, depending on the trajectories of the travel elements of the vehicle(s) or machine combination(s) carrying out the subsequent operation(s) on these current portions,
providing and in taking into account the specific trajectories of the vehicle(s) or machine combination(s) carrying out the subsequent above-mentioned operation(s) at least during cornering, during U-turns or between the current portions, and in controlling the seeding vehicle or machine combination to carry out controlled seeding with tramlining also during these specific trajectories.

2. The method according to claim 1, further comprising determining and taking into account the specific trajectories of the vehicle(s) or machine combination(s) carrying out the above-mentioned subsequent operation(s) during maneuvers associated with avoiding objects or obstacles, with entering or leaving the plot, with operations to load or supply inputs or with specific foreseeable operations, depending for example on the type of plant cultivated on the plot considered, the characteristics of its soil and/or the type of vehicle or machine combination concerned.

3. The method according to claim 1, comprising providing in advance, for the foreseeable maneuvers, models of the trajectories of the travel means of the various vehicles or machine combinations carrying out the subsequent operation(s) likely to be implemented on the plot considered, taking into account a possible error or shift factor determined by measurements during implementations under real conditions.

4. The method according to claim 1, wherein the virtual plan of the plot also comprises a division of its surface into work areas in relation with seeding recommendations, such as modulation of the dose of seed and/or fertilizer to be deposited, working speed, working depth, adjustment specific to at least one operating parameter of the seeding vehicle or machine combination or similar.

5. The method according to claim 1, characterized in that wherein the controlled seeding of the plot is carried out by a robot-controlled vehicle, operating autonomously or controlled remotely, having a working width that is advantageously an integer submultiple of the working widths of the various vehicles or machine combinations carrying out the subsequent operation(s) likely to be implemented on the plot considered, the latter also advantageously being of the robot-controlled machine type, operating autonomously or controlled remotely.

6. A system for the implementation of the method for the controlled seeding according to claim 1, comprising a seeding vehicle or a machine combination with a seeder, that is autonomous or semi-autonomous, having a plurality of single seeding elements, each able and intended to produce a seeding row, this vehicle or machine combination being configured so as to be able to selectively, and at least temporarily, interrupt one, several or all the seeding row(s), by blocking and possibly retracting the element(s) concerned,
wherein the vehicle or machine combination is equipped with control means comprising a computer means configured to use a virtual plan of the plot to be sown and to define and execute a protocol for the travel and operation of said vehicle or machine combination configured to carry out controlled seeding with selective tramlining over the entire plot considered, according to the trajectories of the travel elements of the vehicle(s) or machine combination(s) carrying out the operation(s) subsequent to the seeding of this plot.

7. The system according to claim 6, wherein the seeding vehicle or machine combination is of the robot-controlled vehicle type, operating autonomously, semi-autonomously or controlled remotely.
